(19) United States
(12) Patent Application Publication
(10) Pub. No.: US 2008/0077953 A1
(43) Pub. Date: Mar. 27, 2008

(54) Video background replacement system

(75) Inventors: Raul J. Fernandez, Potomac, MD (US); Alan J. Lipton, Herndon, VA (US); Peter L. Venetianer, McLean, VA (US); Zhong Zhang, Herndon, VA (US)

Correspondence Address: VENABLE LLP, P.O. BOX 34385, WASHINGTON, DC, 20043-9998, US

(73) Assignee: ObjectVideo, Inc., Reston, VA (US)

(21) Appl. No.: 11/902,480

(22) Filed: Sep. 21, 2007

Related U.S. Application Data
(60) Provisional application No. 60/846,336, filed on Sep. 22, 2006.

(51) Int. Cl. H04N 7/10

(52) U.S. Cl. 725/32

(57) ABSTRACT

A video is obtained. The obtained video is transmitted. An advertising content is provided. The transmitted video is received. A background from the video is segmented. The segmented background is replaced with the advertising content. The video with the replaced background is rendered on a monitor.

### CROSS-REFERENCE TO RELATED PATENTS AND PATENT DOCUMENTS

The following patents and patent documents, the subject matter of each is being incorporated herein by reference in its entirety, are mentioned:

U.S. Pat. No. 7,046,732, by Slowe et al., entitled “Video Coloring Book,” issued May 16, 2006;

U.S. Pat. No. 6,987,883, by Lipton et al., entitled “Video Scene Background Maintenance Using Statistical Pixel Modeling,” issued Jan. 17, 2006;

U.S. Pat. No. 6,954,498, by Lipton, entitled “Interactive Video Manipulation,” issued Oct. 11, 2005;

U.S. Pat. No. 6,738,424, by Allmen et al., entitled “Scene Model Generation From Video For Use In Video Processing,” issued May 18, 2004;

U.S. Pat. No. 6,625,310, by Lipton et al., entitled “Video Segmentation Using Statistical Pixel Modeling,” issued Sep. 23, 2003;

U.S. Published Patent Application No. 2007/0160289, by Lipton et al., entitled “Video Segmentation Using Statistical Pixel Modeling,” published Jul. 12, 2007;

U.S. Published Patent Application No. 2007/0052803, by Chosak et al., entitled “Scanning Camera-Based Video Surveillance System,” published Mar. 8, 2007; and

U.S. patent application Ser. No. 09/956,971, by Slowe et al., entitled “Video Editing System Using Fixed-Frame And Camera-Motion Layers,” filed Sep. 21, 2001, Docket No. 37112-173581.

### BACKGROUND

The following relates to image processing. More particularly, the following relates to video conferencing where the source video background may be replaced with a selected replacement background. However, the following also finds application in video streaming of events over web, television, cable, and the like.

Video cameras have been in use for many years now. There are many functions they serve, but one of the most prevalent is video teleconferencing. Inexpensive webcams are used for personal teleconferences from home offices or laptops, and more expensive complete video systems are used for more professional teleconferences. In some environments, omni-directional cameras provide teleconferencing capabilities for all participants seated around a conference table. Pan-tilt-zoom (PTZ) cameras are sometimes used to track multiple participants during a teleconference. Even video-enabled wireless devices such as cell phones and PDAs can provide video teleconferencing.

Background replacement involves the process of separating foreground objects from the background scene and replacing the background with a different scene. Traditional background replacement using blue-screen or green-screen technology has been used for years in the movie and TV industries. The easiest example to visualize is the blue-screen technology used by weather forecasters on TV news shows. Here, the forecaster, standing in front of a blue or green screen is overlaid, in real-time, onto a weather map. Personal background replacement technologies are just now entering the market. These technologies allow a user with a web-cam (or other video device) to partake in a video teleconference and have their background environment replaced with an image or even video of their own choosing. The effect is that the participant appears to everyone else in the teleconference to be in a different location, or taking part in some different action than is actually the case.

One difference between personal background replacement technologies and blue or green screen technologies is that the personal background replacement technologies are in real-time. Some green screen technologies require after-the-fact editing to achieve the desired effect. For video teleconferencing, the system must operate in real-time.

Another difference between personal background replacement technologies and blue or green screen technologies is that the personal background replacement technologies do not require a special background. In fact, the system employing personal background replacement technologies must work in any background environment including one that contains spurious motion effects.

### SUMMARY

An exemplary embodiment of the invention includes a method for video background replacement in real time, including: obtaining a video; transmitting the obtained video; receiving the transmitted video; and rendering the video with a replaced background on a monitor, wherein the method further comprises obtaining an advertising content and one of: (a) segmenting a background from the video and replacing the segmented background with the advertising content after obtaining the video and prior to transmitting the obtained video; (b) segmenting a background from the video prior to transmitting the obtained video and replacing the segmented background with the advertising content after receiving the transmitted video; or (c) segmenting a background from the video and replacing the segmented background with the advertising content after receiving the transmitted video.

An exemplary embodiment of the invention includes a system for video background replacement in real time, including: a transmitting device to obtain and transmit a video; an advertising server to provide an advertising content via a network; a segmentation component to segment a background from the video; a replacement component to replace the segmented background with the advertising content; and a receiving device to receive the video and render the video with the replaced background on a monitor.

An exemplary embodiment of the invention includes a computer-readable medium holding computer-executable instructions for video background replacement in real time, the medium including: instructions for obtaining a video; instructions for transmitting the obtained video; instructions for receiving the transmitted video; instructions for rendering the video with a replaced background on a monitor; and instructions for obtaining an advertising content and one of: (a) segmenting a background from the video and replacing the segmented background with the advertising content after obtaining the video and prior to transmitting the obtained video; (b) segmenting a background from the video prior to transmitting the obtained video and replacing the segmented background with the advertising content after receiving the transmitted video; or (c) segmenting a background from the video and replacing the segmented background with the advertising content after receiving the transmitted video.

### BRIEF DESCRIPTION OF THE DRAWINGS

The foregoing and other features and advantages of the invention will be apparent from the following, more particular description of the embodiments of the invention, as illustrated in the accompanying drawings.

FIG. 1 illustrates a flowchart for an exemplary embodiment of the invention;

FIG. 2 illustrates a flowchart for video processing for background replacement according to an exemplary embodiment of the invention;

FIG. 3A illustrates the video processing occurring at the source according to an exemplary embodiment of the invention;

FIG. 3B illustrates a split processing approach according to an exemplary embodiment of the invention;

FIG. 3C illustrates the processing performed at the receiving side according to an exemplary embodiment of the invention;

FIG. 4 illustrates a system overview for an exemplary embodiment of the invention;

FIG. 5 illustrates an exemplary embodiment of the invention;

FIG. 6 illustrates an exemplary embodiment of the invention;

FIG. 7 illustrates an exemplary embodiment of the invention;

FIG. 8 illustrates an exemplary embodiment of the invention;

FIG. 9 illustrates images from an exemplary video processed according to an exemplary embodiment of the invention;

FIG. 10 illustrates an exemplary embodiment using a PTZ camera according to an exemplary embodiment of the invention;

FIGS. 11A and 11B illustrate an exemplary embodiment using an omni-directional camera video teleconferencing system according to an exemplary embodiment of the invention;

FIGS. 12A and 12B illustrate an exemplary embodiment using an omni-directional camera video teleconferencing system according to an exemplary embodiment of the invention;

FIG. 13A illustrates an example of alpha blending;

FIG. 13B illustrates an example of alpha blending;

FIG. 14 illustrates an exemplary flowchart for segmentation and filtering according to an exemplary embodiment of the invention;

FIG. 15 illustrates an exemplary flowchart for high confidence video segmentation according to an exemplary embodiment of the invention;

FIG. 16 illustrates an exemplary flowchart for generating a high confidence background mask according to an exemplary embodiment of the invention;

FIG. 17 illustrates an exemplary flowchart for final video segmentation according to an exemplary embodiment of the invention;

FIGS. 18A-18F illustrate images processed according to an exemplary embodiment of the invention; and

FIG. 19 depicts a computer system for an exemplary embodiment of the invention.

### DEFINITIONS

In describing the invention, the following definitions are applicable throughout (including above).

“Video” may refer to motion pictures represented in analog and/or digital form. Examples of video may include: television; a movie; an image sequence from a video camera or other observer; an image sequence from a live feed; a computer-generated image sequence; an image sequence from a computer graphics engine; an image sequences from a storage device, such as a computer-readable medium, a digital video disk (DVD), or a high-definition disk (HDD); an image sequence from an IEEE 1394-based interface; an image sequence from a video digitizer; or an image sequence from a network.

A “video sequence” may refer to some or all of a video.

A “video camera” may refer to an apparatus for visual recording. Examples of a video camera may include one or more of the following: a video imager and lens apparatus; a video camera; a digital video camera; a color camera; a monochrome camera; a camera; a camcorder; a PC camera; a webcam; an infrared (IR) video camera; a low-light video camera; a thermal video camera; a closed-circuit television (CCTV) camera; a pan, tilt, zoom (PTZ) camera; and a video sensing device. A video camera may be positioned to perform surveillance of an area of interest.

“Video processing” may refer to any manipulation and/or analysis of video, including, for example, compression, editing, surveillance, and/or verification.

A “frame” may refer to a particular image or other discrete unit within a video.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, or a chip set; a system on a chip (SoC), or a multiprocessor system-on-chip (MPSoC); an optical computer; a quantum computer; a biological computer; and an apparatus that may accept data, may process data in accordance with one or more stored software programs, may generate results, and typically may include input, output, storage, arithmetic, logic, and control units.

“Software” may refer to prescribed rules to operate a computer. Examples of software may include: software; code segments; instructions; applets; pre-compiled code; compiled code; interpreted code; computer programs; and programmed logic.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash removable memory; a memory chip; and/or other types of media that can store machine-readable instructions thereon.

A “computer system” may refer to a system having one or more computers, where each computer may include a computer-readable medium embodying software to operate the computer. Examples of a computer system may include: a distributed computer system for processing information via computer systems linked by a network; two or more computer systems connected together via a network for transmitting and/or receiving information between the computer systems; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet. Exemplary networks may operate with any of a number of protocols, such as Internet protocol (IP), asynchronous transfer mode (ATM), and/or synchronous optical network (SONET), user datagram protocol (UDP), IEEE 802.x, etc.

### DETAILED DESCRIPTION OF THE EXEMPLARY EMBODIMENTS

In describing the exemplary embodiments of the present invention illustrated in the drawings, specific terminology is employed for the sake of clarity. However, the invention is not intended to be limited to the specific terminology so selected. It is to be understood that each specific element includes all technical equivalents that operate in a similar manner to accomplish a similar purpose. All examples are exemplary and non-limiting.

The present invention provides a unique capability to video teleconference participants. In an exemplary embodiment, participants may “opt-in” to an advertising function having innovative properties. The background of a participant may be replaced in whole or in part by an advertising content supplied by, for example, a third party service. Participants may choose to opt-in to or out of particular advertising campaigns, that they like or dislike. The advertising content may be a still imagery or a video imagery and may be rotated on a time-basis in the participant's background. The advertising content may be modified for each recipient based on personal profile information such as geographic region, shopping habits, personal information, etc. This information may be obtained either directly through the user-defined profile information, or via information “learned” by observing the user's web-surfing and web-shopping habits.

In one embodiment, speech recognition technology may be used to monitor the content of video teleconferences or broadcasts. Advertising content may be created based on key words being spoken by participants. For example, if participants in the teleconference or web-cast start talking about cars, advertising material pertaining to automobiles or automobile services or products may be used as a background replacement content.

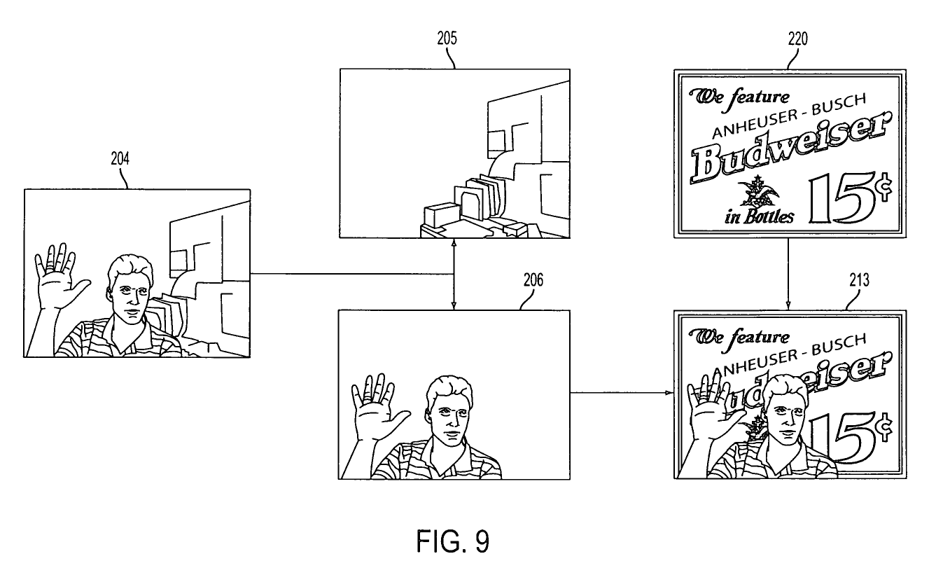

FIG. 9 illustrates images from an exemplary video processed according to an exemplary embodiment of the invention. A teleconference participant in an office environment (block 204) may opt-in to the background replacement process according to an exemplary embodiment of the invention. In real-time, the participant's video teleconference stream may be split into a foreground segmentation (block 206) and a background (block 205). The background 205 may be replaced by a third party advertising content (block 220) that provides a back-drop for the participant's video teleconference stream (block 213). E.g., a new video stream is produced.

There are existing technologies that are available for performing such real-world, real-time background/foreground segmentation, such as described, for example, in: U.S. Pat. No. 6,625,310, U.S. Pat. No. 6,987,883, and U.S. Published Patent Application No. 2007/0160289, identified above. These technologies address segmentation of foreground from the background in a manner that is particularly robust to environmental noise such as rain, snow, wind blowing through leaves and water, etc. Other existing technologies that interact with background layers may also be used, such as described, for example in: U.S. Pat. No. 6,954,498; and U.S. patent application Ser. No. 09/956,971, identified above.

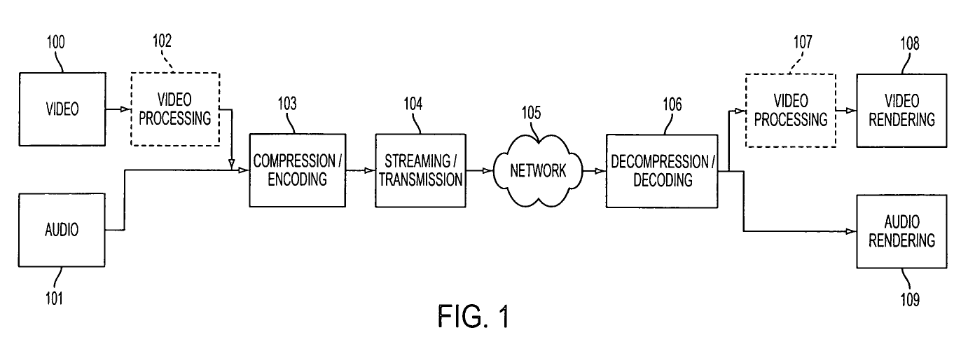

FIG. 1 illustrates a flowchart for an exemplary embodiment of the invention having a video streaming process for a video teleconference. Video (block 100) and audio (block 101) may be captured, compressed and encoded (block 103), and streamed or transmitted in real-time (block 104) over a network (block 105) to a recipient. The video 100 and audio 101 may be decompressed and decoded (block 106) and rendered as video (block 108) and audio (block 109). The background replacement or video processing may occur before the video is encoded (block 102), and/or after the video is decoded and is about to be rendered (block 107).

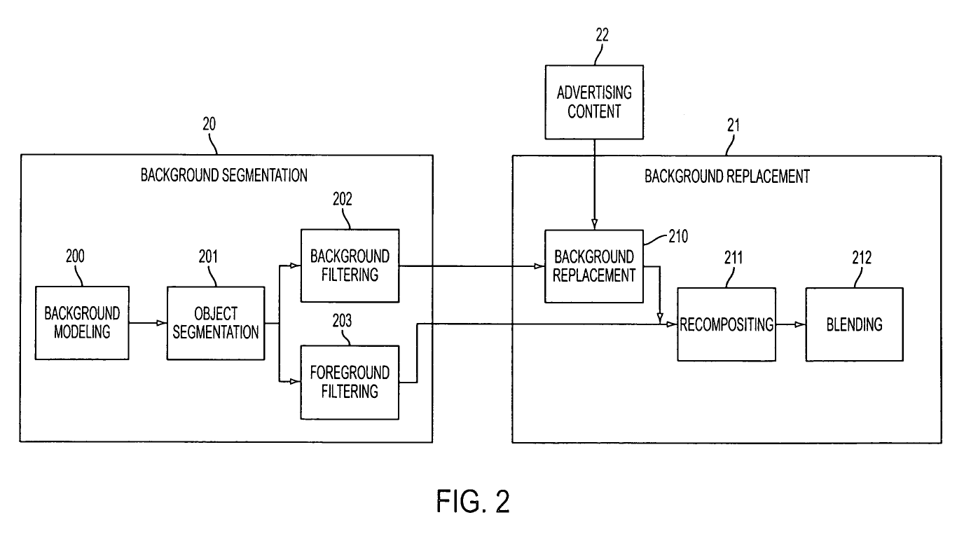

FIG. 2 illustrates a flowchart for video processing in blocks 102, 107 for background replacement. The background replacement may include a background segmentation (block 20) that may be used to separate foreground objects from the background; and a background replacement (block 21) that may take third party advertising content (block 22) in real-time, and place it behind the foreground object. The third-party advertising content 22 may originate from outside of the video processing 102, 107 and may be provided by a third party content provider.

In the background segmentation (block 20), a background model is constructed (block 200). There are several methods known in the art for achieving this, such as described, for example in: U.S. Pat. No. 6,625,310 and U.S. Published Patent Application No. 2007/0160289, identified above. The described methods are robust to background noise and dynamically adjustable in real-time to environmental phenomena, such as lighting changes, shadows, etc. An object segmentation may be performed on each frame (block 201) to create a foreground mask for each frame. The foreground mask may be filtered (block 203) to ensure a clean segmentation. Optionally, the background mask may be filtered (block 202). An exemplary embodiment of the segmentation and filtering (blocks 201, 202, and 203) is described in detail below.

The foreground segmentation shape and imagery may be transmitted to the second stage of the process, e.g., the background replacement (block 21). Optionally, the background may be transmitted to the background replacement (block 21). In the background replacement (block 21), third party advertising content (block 22) in the form of imagery or video frames may be used to replace the background imagery from the source video (block 210). The new background may be cropped and/or stretched to fit the dimensions of the original video source. The video may be recomposited (block 211). Recompositing may involve placing the foreground segmentation over the new background. Some small artifacts may be introduced by the recompositing process. For example, pixels on the edge of the shape may contain some background material that may appear to “bleed through” at the edges creating a halo effect. To mitigate this effect, a blending step may be used (block 212) to allow the edges of the foreground segmentation to become transparent and allow some of the new background imagery to show through. This process may include an alpha blending.

For alpha blending (block 212), foreground pixels on the edge of the shape may be blended with new background pixels to allow the background to blend seamlessly with the foreground. A foreground pixel x on the edge of the shape may have intensity I_{fg}(x)=[R_{fg},G_{fg},B_{fg}] (assuming a red-green-blue (RGB) color space). The background pixel at the same location may have intensity I_{bg}(x)=[R_{bg},G_{bg},B_{bg}]. The blended pixel at that location may have intensity I(x)=αI_{fg}+(1−α)I_{bg}, where alpha is the blending constant determined by a number of foreground pixels in a 3×3 pixel neighborhood around the target pixel. For example, α=N_{fg}/8 where N_{fg} is the number of foreground pixels in the pixel neighborhood around the pixel x.

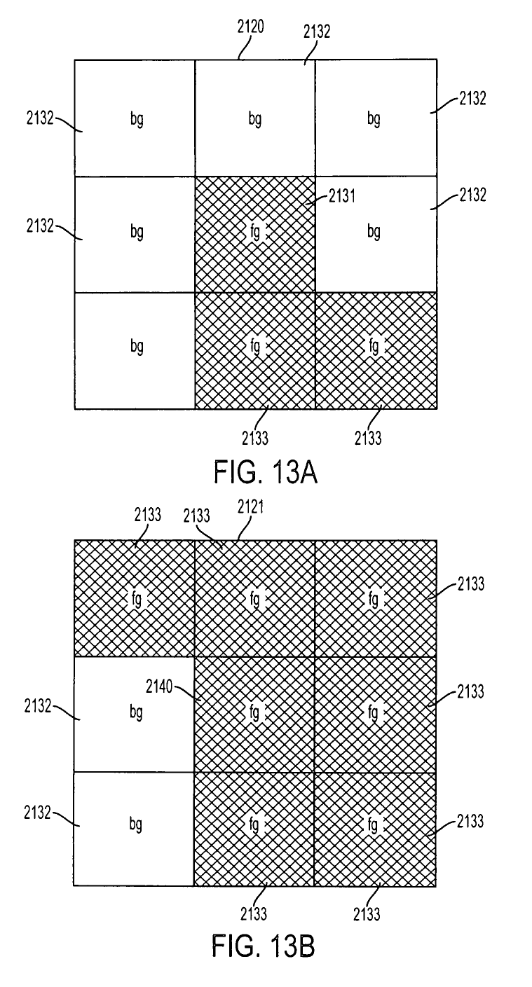

FIGS. 13A and 13B illustrate examples of alpha blending. In area 2120 of an exemplary image of FIG. 13A, a center pixel 2131 is surrounded by six background pixels 2132 and two foreground pixels 2133. In this case, alpha is equal to 2/8, which results in the center pixel 2131 being mostly background. In area 2121 of an exemplary image of FIG. 13B, a center pixel 2140 is surrounded by six foreground pixels 2133 and two background pixels 2132. In this case, alpha is equal to 6/8, which results in this pixel being mostly foreground.

Because the video processing 102, 107 may be split into two components, e.g., the background segmentation (block 20) and background replacement (block 21), the system may be configured in several different ways.

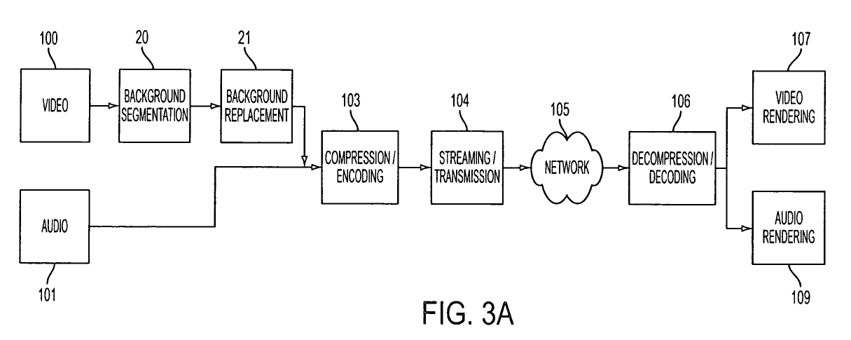

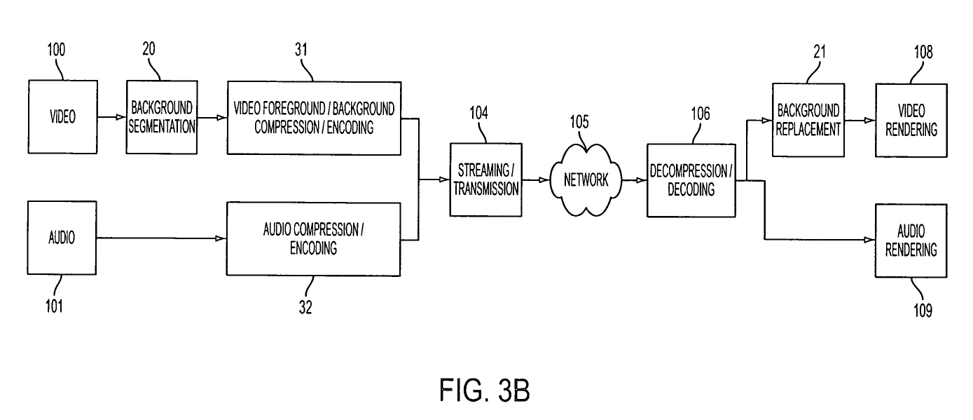

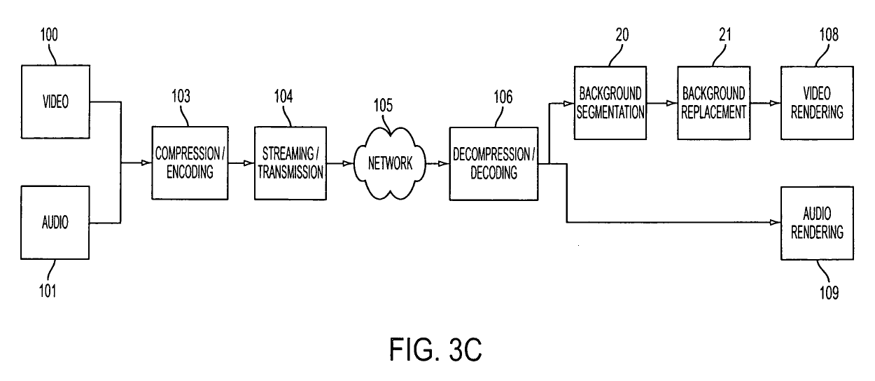

In FIG. 3A, the video processing (blocks 20 and 21) may occur at the source. With this configuration, a new video stream may be created at the source, compressed (block 103), and transmitted (block 104) to the receiver for rendering (block 108) via the network 105.

In FIG. 3B, a split processing approach may be employed. The audio stream may be compressed and streamed (blocks 32 and 104) via the network 105. The video may be split into foreground and background components by the background segmentation (block 20). The foreground and, optionally, background segments may be streamed to the receiver via the network 105 where background replacement (block 21) may take place. A number of different approaches may be used for compressing and streaming the foreground and background components (block 31). In one exemplary embodiment, a new video stream may be created with the foreground components on a uniform background of a prescribed color, which effectively turns the video stream into a blue screen or green screen video. In another exemplary embodiment, an object-based compression scheme may be used. Examples of such compression schemes include MPEG4 main profile and MPEG7. This approach may allow the background replacement to occur at the receiver (or somewhere else in the network). If there are multiple recipients of the video feed, each may have a different set of advertising content in their version of the video feed.

In FIG. 3C, the processing may be performed at the receiving side. A source video may be transmitted. The background segmentation (block 20) and background replacement (block 21) may be performed remotely. For example, the background replacement may occur at the receiver (or somewhere else in the network). If there are multiple recipients of the video feed, each recipient may have a different advertising content in their version of the video feed. If the source of the video is resource limited, such as a PDA or cell phone, the video processing may be performed elsewhere as, for example, at the receiver or a back-end server where there are more resources. If one or more recipients of the stream wish to opt-out of the advertising program, the recipient(s) may view the un-altered video.

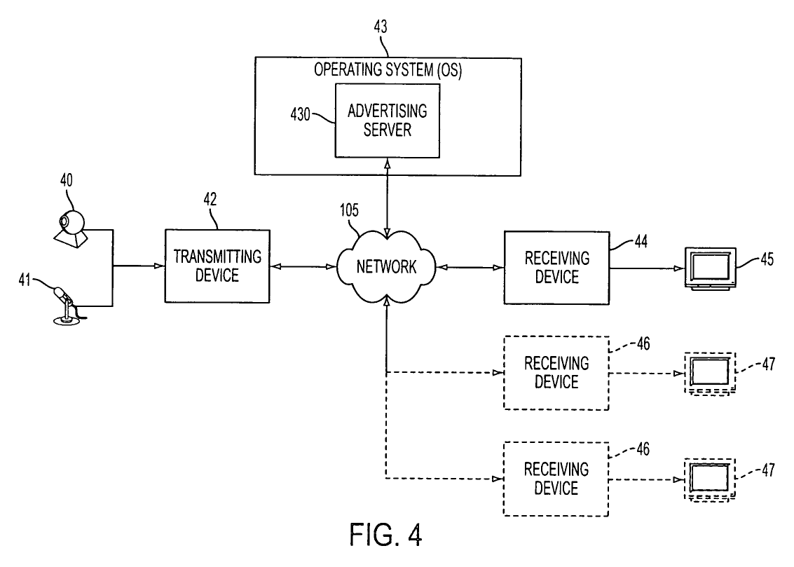

FIG. 4 illustrates a system overview for an exemplary embodiment of the invention. A transmitting device 42 may receive video from a video camera 40 and audio from an audio receiver 41. The transmitting device 42 may be, for example, a video-enabled wireless device, e.g., a PDA or a cell phone, a web-cam on a PC, a web-cam on a laptop, a video teleconferencing system in a home or professional office, or any other device for video teleconferencing. The transmitting device 42 may be streaming video via a network 105 to at least one receiving device 44, which renders the audio and video on, for example, a monitor 45. The system may include multiple receiving devices 46 and respective monitors 47, which may be used in a case of a video “broadcast” or multi-participant video teleconference. Advertising content may be provided by an advertising server 430. The advertising server 430 may include a software or hardware application that determines which advertising content to use to replace the background (in whole or in part) of a video stream for a particular participant. The advertising server 430 may reside in a number of places 43, such as, for example: in an operating system (OS); as part of a service offered by an internet service provider (ISP); as part of an Internet community; or as part of any other third party service provider's offering.

With this approach, a subscriber may opt-in to the background replacement service. A subscriber may choose to opt in or out of particular products or advertising campaigns. Relevant advertising content may be controlled and may not need to be released to either subscribers or recipients of video. Advertising content may be rotated on a time basis in real-time during a teleconference allowing multiple advertising opportunities. Advertising content may be tailored to individual recipients based on their preferences and profiles.

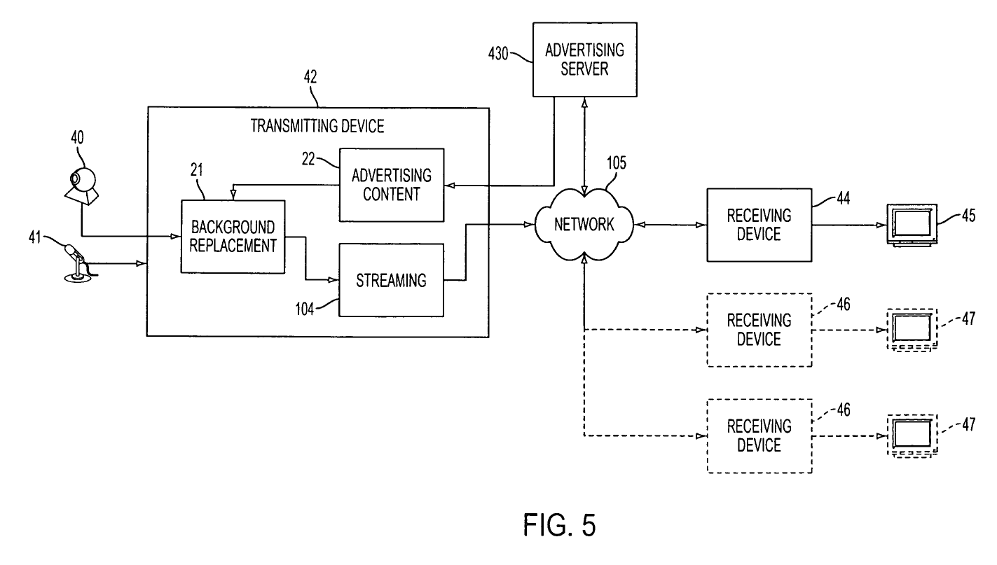

FIG. 5 illustrates an exemplary embodiment of the invention. The advertising server (block 430) may send advertising content (block 22) to the transmitting device (block 42) in real-time. The transmitting device (block 42) may perform the background replacement (block 21) and stream the new video (block 104) to the receiving device (block 44) for rendering on the monitor (block 45) or the multiple receiving devices 46 for rendering on multiple monitors 47. In this embodiment, advertising content (block 22) may be embodied within the transmitting device (block 42).

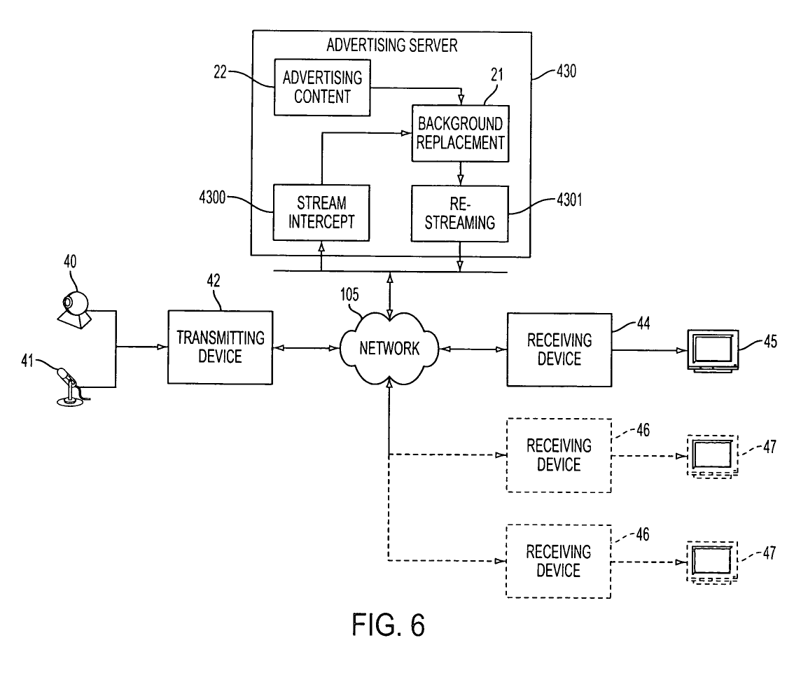

FIG. 6 illustrates an exemplary embodiment of the invention. The video 100 and the audio 101 may be transmitted (block 42) via the network 105 to the advertising server 430. The advertising server (block 430) may intercept the video stream (block 4300) and uncompress and decode the intercepted video stream. The background replacement (block 21) may be performed with advertising content (block 22). The newly composited video may be re-streamed (block 4301) to the receiving device(s) (blocks 44 and 46). In this embodiment, the advertising content 22 resides within the advertising server 430. Multiple different streams with different advertising content may be created for multiple end users.

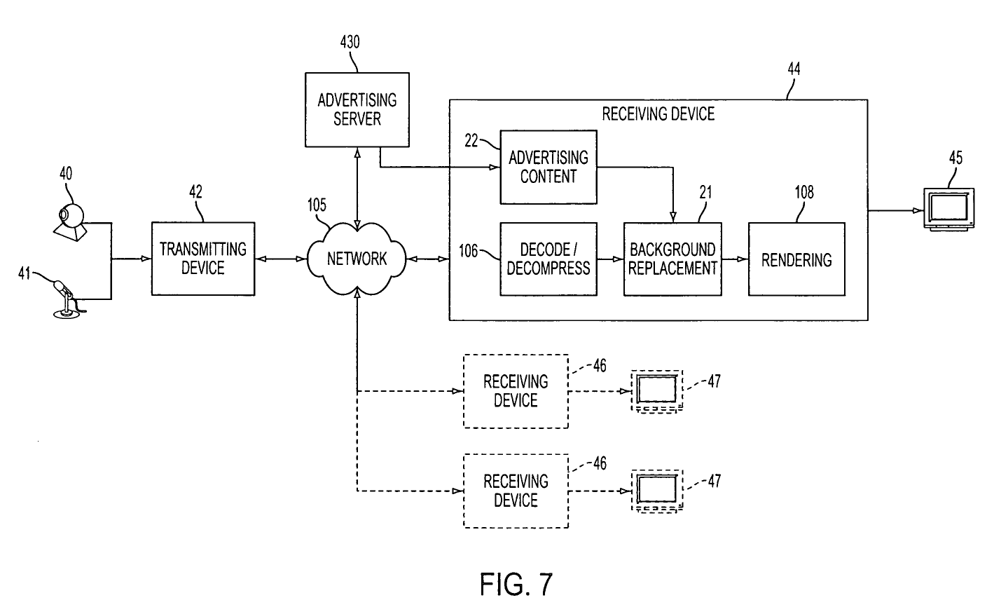

FIG. 7 illustrates an exemplary embodiment of the invention. Advertising content (block 22) may be streamed by the advertising server (block 430) to the receiving device (block 44). The background replacement (block 21) may be performed locally by the receiving device. The final video stream may be rendered (block 108) on the monitor (block 45). This process may be duplicated on multiple receiving devices and monitors (blocks 46 and 47) if the video stream is intended for multi-cast or there are multiple participants in the video teleconference. Each receiver may have a different set of advertising content based on their preferences.

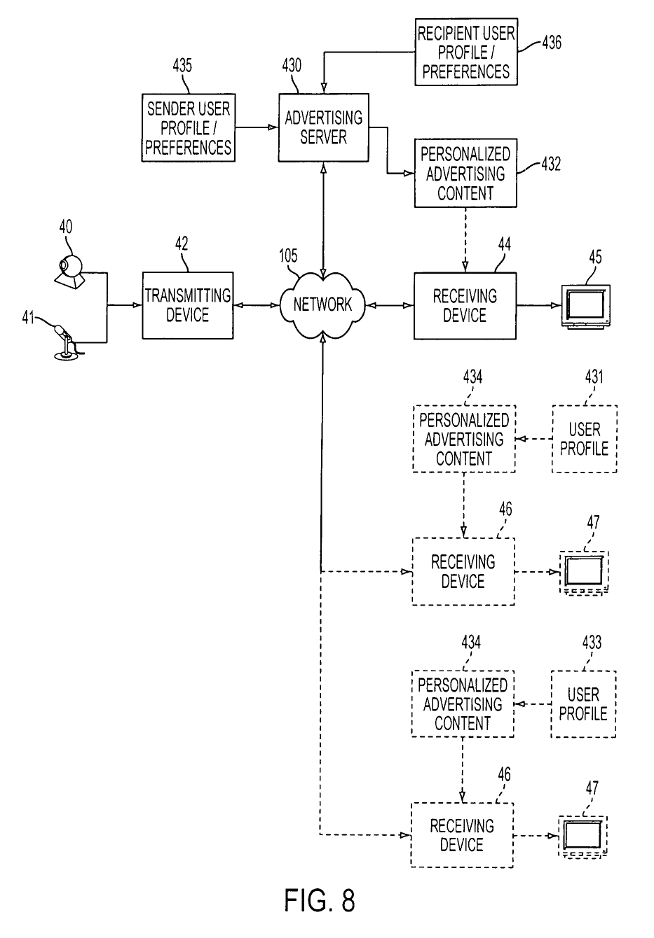

FIG. 8 illustrates an exemplary embodiment of the invention. Each receiver may receive a personalized version of the advertising content (blocks 432 and 434) based on the user profile (blocks 431, 433, 436) of the individual participant. Each participant may receive advertising material that may be relevant to the participant based on interests of the participant. If the participant is an automobile enthusiast, the advertising material may be car or accessory advertising. If the participant is interested in the housing market, the advertising material may be real-estate advertising. There are several potential sources of profile information. For example, as a user signs up to an ISP or internet community, the user may typically input profile information specific to the user, such as, for example: geography; income, job, salary, etc.; and other personal information. Another source of profile information may be the web-surfing or web-shopping habits of people on-line. In one embodiment, a source of profile information may be the content of the video teleconference that may be gleaned by a speech recognition system. If this information is available to the advertising server via an ISP or other third party service provider, a tailored advertising message may be created for the participant by the advertising server. Of course, a participant may choose preferences to opt-out of the advertising program, or opt-in to advertising content about particular types of goods or services. The same options may be available to the sender (block 435). The sender may choose to opt in or out of particular advertising campaigns or particular types of goods and services. Likewise, the choice of advertising content may be based on the sender's profile.

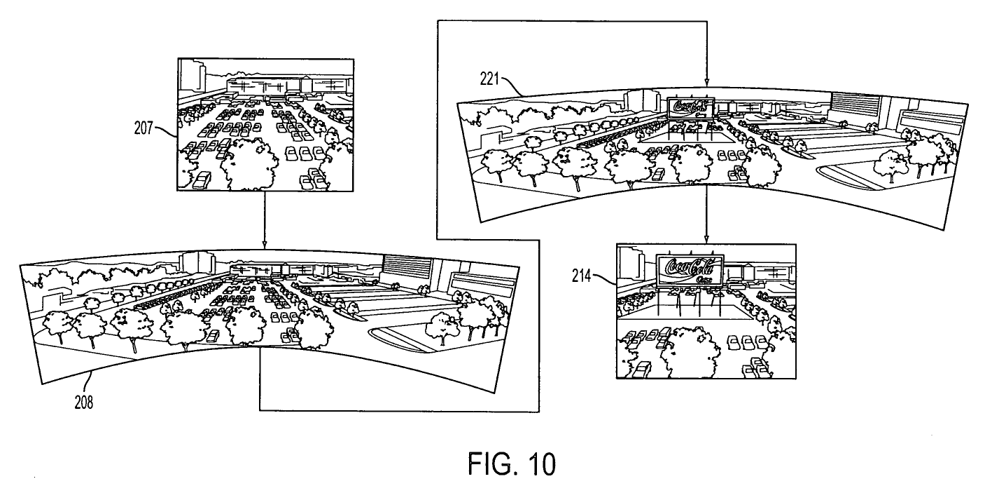

FIG. 10 illustrates an exemplary embodiment using a pan tilt zoom (PTZ) camera. A scene captured by a PTZ camera may be converted in real-time into a mosaic background. Techniques to accomplish this are discussed in, for example: U.S. Pat. No. 6,738,424, U.S. patent application Ser. No. 09/956,971, U.S. Pat. No. 7,046,732, U.S. Pat. No. 6,987,883, and U.S. Published Patent Application No. 2007/0052803, identified above. The source video (block 207) may be segmented into a background mosaic in real time (block 208). The background mosaic may be modified in whole or in part with advertising content (block 221). The video may be reconstituted (block 214). In this example, a billboard is added to a parking lot in the scene.

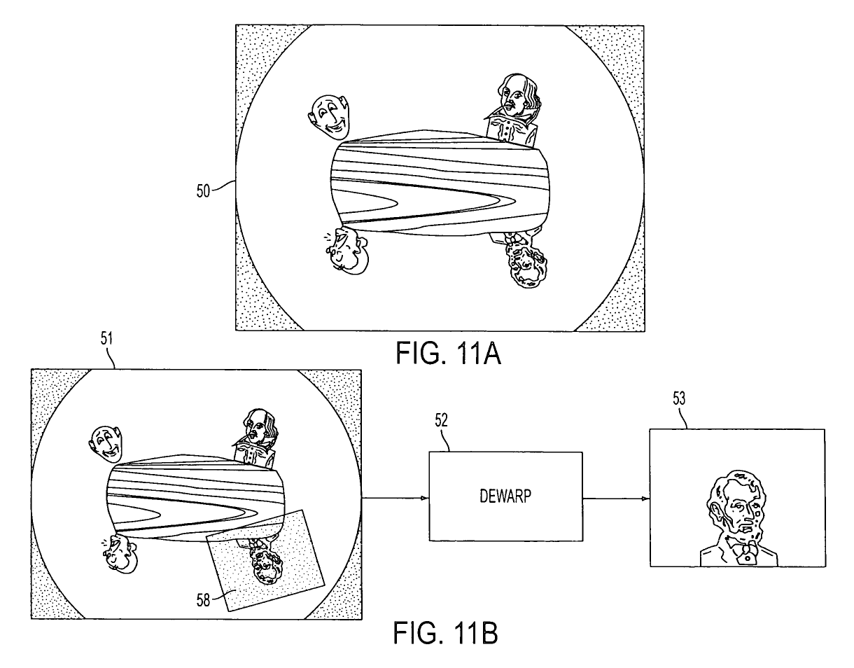

FIGS. 11A and 11B illustrate an exemplary embodiment using an omni-directional camera video teleconferencing system. For example, an omni-directional camera may be mounted in the center of a room to obtain a view of all participants sitting, for example, around a table. The omni-directional camera technology may typically be based on curved mirrors, fish-eye lenses, or a combination of the above. In image 50 of FIG. 11A, an exemplary scene is depicted with four people sitting around a conference table. In this type of video teleconferencing, one or more “virtual” PTZ cameras may focus on one or more of the participants (block 51). As shown in FIG. 11B, the camera is focused on a target 58. The virtual view may be dewarped (block 52) at rendering time to display an unwarped image of the target speaker (block 53).

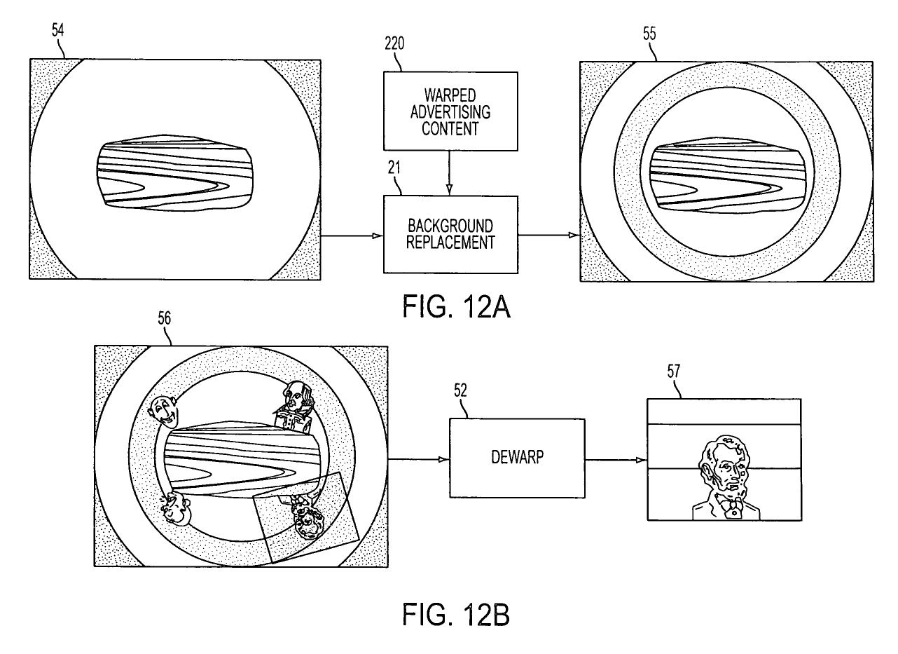

In FIG. 12A, a background segmentation (block 54) may be performed. The background may be replaced or augmented (block 21) with a warped version of the advertising content (block 220). Warped advertising content superimposed on the background is shown in block 55. As shown in FIG. 12B, when a virtual PTZ view is rendered (block 56), the advertising content may be dewarped (block 52) along with the foreground object. The unwarped advertising content may be visible to the recipient of the stream along with the target speak (block 57).

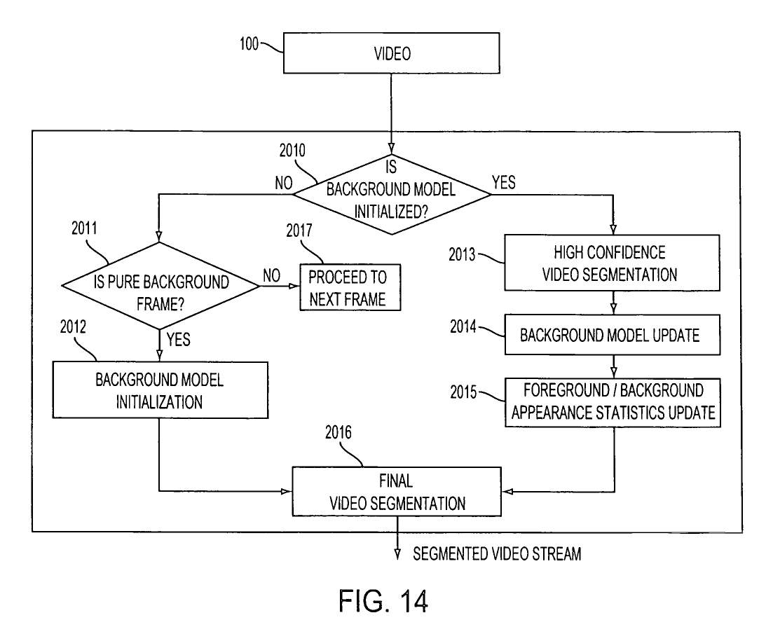

FIGS. 14-17 illustrate an exemplary embodiment for segmentation and filtering (blocks 201, 202, and 203).

FIG. 14 illustrates an exemplary flowchart for segmentation and filtering (blocks 201, 202, and 203). A video stream (block 100) may be received. If the background model is not initialized (block 2010), a determination may be made as to whether the frame is pure background or includes any foreground material (block 2011). This may be determined by one of the motion detection algorithms such as a 2-frame or a 3-frame differencing known in the art. If the frame is pure background, the background model is initialized (block 2012). In an exemplary embodiment, the background model may include a 3-band mean and standard deviation values for each pixel and 3-band horizontal and vertical gradient values for each pixel in the mean image. If the frame is not pure background, flow proceeds to the next frame (block 2017).

If the background is initialized (as determined by block 2010), a high confidence segmentation may be performed (block 2013). The high confidence segmentation produces two output masks: a high confidence foreground mask of pixels that are almost certainly foreground; and a high confidence background mask of pixels that are almost certainly background. The pixels that are definitely background may be used to update the background model (block 2014) by means such as an infinite impulse response (IIR) filter as described in, for example, U.S. Published Patent Application No. 2007/0160289, identified above. In an exemplary embodiment, only the pixels in the high confidence background mask may be updated. Appearance statistics of the background and foreground regions may be updated (block 2015). This may be performed by creating two cumulative histograms of three-dimensional (3D) color values for each pixel: one for when the pixel is a high confidence foreground pixel; and the other for when the pixel is a high confidence background pixel. Based on the high-confidence foreground and background masks, and the statistical properties such as mean and standard deviations and edges of the foreground and background regions, a final segmentation (block 2016) may be based on the pixels that are in the foreground and the pixels that are in the background.

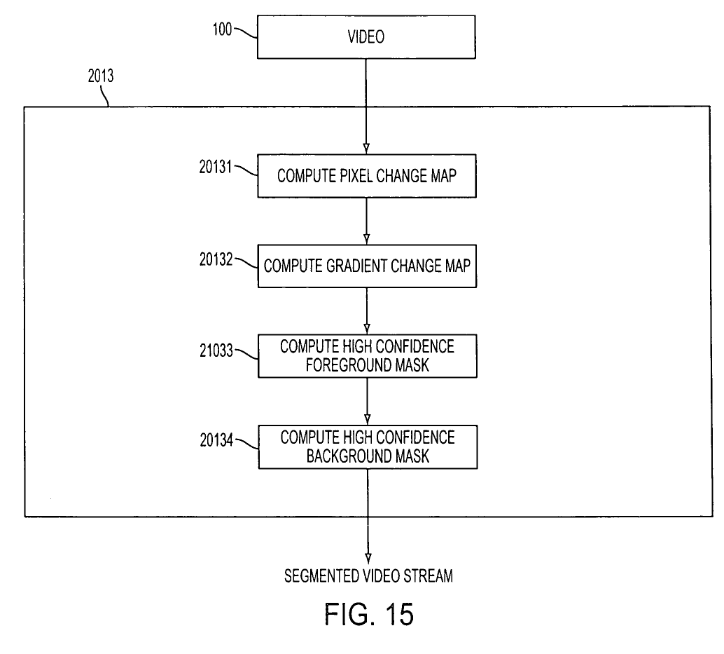

FIG. 15 illustrates an exemplary flowchart for high confidence video segmentation (2013), in which the high-confidence foreground mask and the high-confidence background mask are generated. Pixel change maps may be generated (block 20131). For example, two maps may be created. The first pixel change map may be a map of absolute difference in 3D color space between the pixel in the current frame and the mean of a corresponding pixel in the background model. The second pixel change map may be a normalized version of the first map where the absolute difference is normalized by the standard deviation of a corresponding pixel. A gradient change map may be generated (block 20132) where each element of the gradient change map may be the absolute difference between a gradient of a pixel in the current frame and the corresponding gradient of that pixel in the background model.

A high confidence foreground mask may be generated (block 21033) based on pre-specified rules. For example, the absolute and normalized pixel difference may be large. The pixel may have a low gradient in the background image. High confidence foreground pixels may be filtered using a neighborhood filtering approach, such as, for example, a median filter. Foreground pixels that have many neighbors that are also foreground pixels may be retained. Foreground pixels with few neighboring foreground pixels may be excluded from the mask.

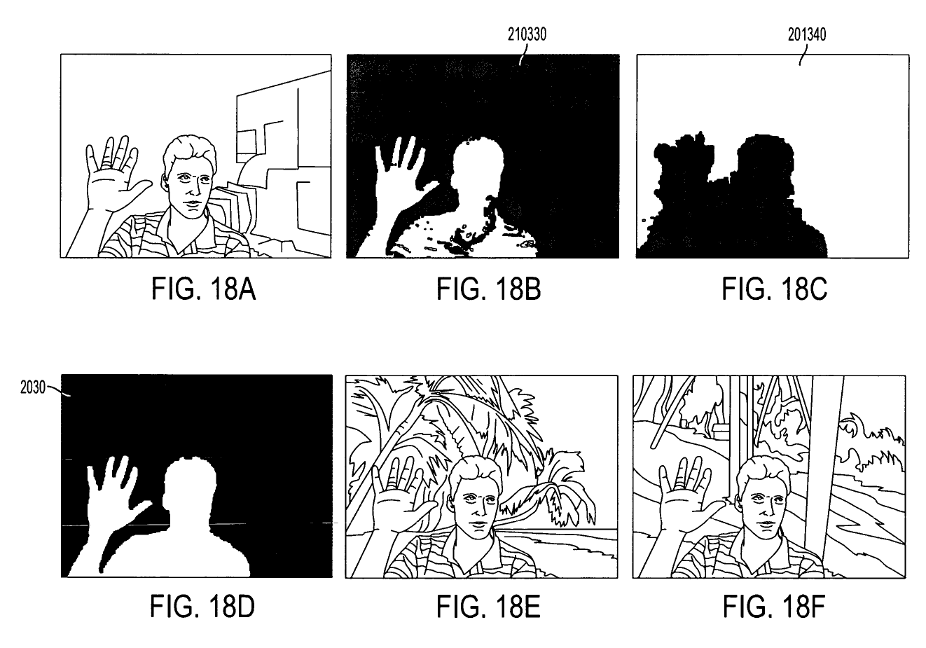

FIGS. 18A-18F illustrate images from an exemplary video processed according to an exemplary embodiment of the invention. In FIG. 18A, image 204 illustrates a source video. In FIG. 18B, image 210330 illustrates a high confidence foreground mask.

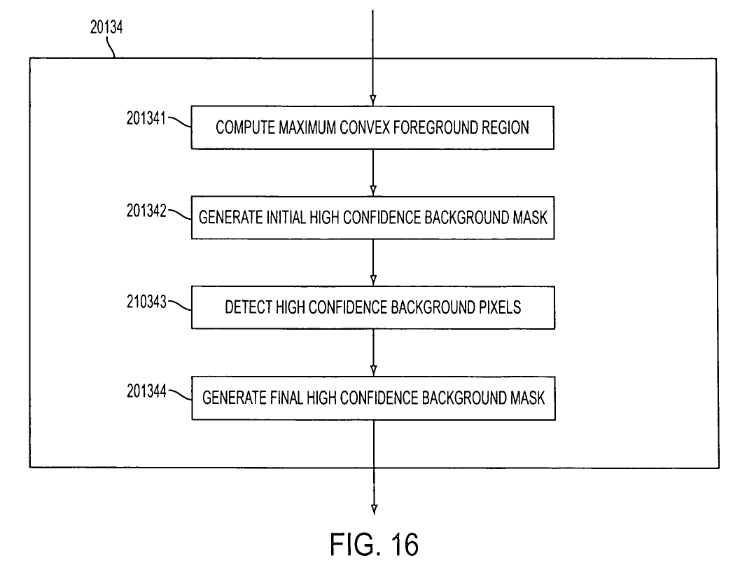

FIG. 16 illustrates an exemplary flowchart for generating a high confidence background mask (block 20134). A maximum convex foreground region may be generated (block 201341) from the high confidence foreground mask generated in block 21033. This may be accomplished by performing a tentative region growing by a known technique to produce a tentative foreground mask. Morphological dilation may be used to obtain a maximum tentative foreground mask. The maximum convex foreground region may be obtained by performing a convex hull operation around the maximum tentative foreground region.

An initial high confidence background mask may be generated (block 201342). The initial high confidence background mask may be an inverse of the maximum convex foreground region. The initial high confidence background mask may be modified by detecting high confidence background pixels (block 201343). This may be performed by choosing background pixels that have a low gradient difference between the current frame and the background model. A majority neighborhood filter (such as the one described above) may be used to extend the initial high confidence background mask.

A final high confidence background mask may be generated (block 201344). This may be accomplished by performing tight iterative region growing by a known technique starting from the initial high confidence background mask. Image 201340 in FIG. 18C illustrates an exemplary result of the final high confidence background mask.

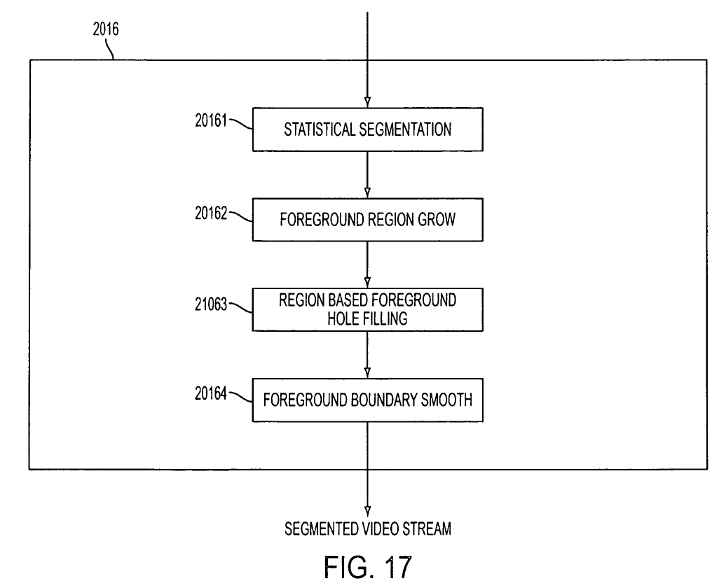

FIG. 17 illustrates an exemplary flowchart for final video segmentation (block 2016). A statistical segmentation may be performed (block 20161). This may be accomplished by setting pixels on the high confidence foreground mask with a value of 1 and pixels on the high confidence background mask with a value of 0. The probabilities for the remaining pixels may be computed based on the following two rules applied to the pixel statistics and mean and gradient models. First, a pixel may have higher probability of being foreground when it has occurred more times in the foreground pixel histogram. Second, the pixel may have a higher probability of being foreground when it has a high pixel change and gradient change. The pixel may be considered foreground if the foreground probability is greater than some threshold (such as, for example, 0.8).

The foreground region may be grown (block 20162). If an uncertain pixel is similar to a neighboring pixel that is a high confidence foreground pixel, the pixel in question may be considered a foreground pixel.

A foreground region hole filling may be performed (block 20163). Each hole may be segmented based on one of the spatial segmentation techniques. If the hole is surrounded by the foreground regions, the average foreground probability of the hole may be determined. If the average foreground probability is greater than some threshold (such as, for example, 0.5), the region may be considered a foreground region.

The foreground region may be smoothed (block 20164). This may be accomplished by conventional morphological erosions and dilations. An exemplary final foreground mask is illustrated in image 2030 of FIG. 18D.

FIGS. 18E and 18F depict composite video frames including a foreground object of FIG. 128A and replacement background.

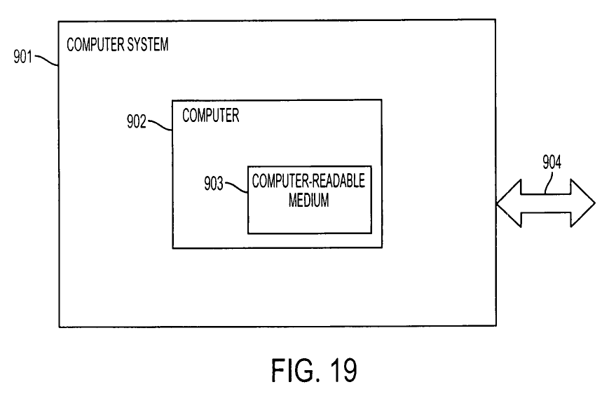

FIG. 19 depicts a computer system 901 for an exemplary embodiment of the invention. The computer system 901 may include a computer 902 for implementing aspects of the exemplary embodiments described herein. The computer 902 may include a computer-readable medium 903 embodying software for implementing the invention and/or software to operate the computer 902 in accordance with the invention. As an option, the computer system 901 may include a connection to a network 904. With this option, the computer 902 may send and receive information (e.g., software, data, documents) from other computer systems via the network 904.

In an exemplary embodiment, referring to FIGS. 4 and 19, the transmitting device (block 42) may be implemented with a first computer system, each of the receiving device(s) (blocks 44 and 45, and blocks 46 and 47) may each be implemented with a second computer system, and the advertising server (block 430) may be implemented with a third computer system.

In an exemplary embodiment, referring to FIGS. 4 and 19, the transmitting device (block 42) may be implemented with a first computer, each of the receiving device(s) (blocks 44 and 45, and blocks 46 and 47) may each be implemented with a second computer, and the advertising server (block 430) may be implemented with a third computer.

The invention is discussed for use with video teleconferencing. However, the invention may be employed for other uses in which video is transmitted over a network. For example, the invention may be used for streaming web events (e.g., concerts, entertainment programs, or news programs).

The invention is discussed where the video is transmitted over a network. However, the invention may be employed with other transmission mediums. For example, the invention may be used with conventional television, cable, or satellite systems.

The invention is described in detail with respect to exemplary embodiments, and it will now be apparent from the foregoing to those skilled in the art that changes and modifications may be made without departing from the invention in its broader aspects, and the invention, therefore, as defined in the claims is intended to cover all such changes and modifications as fall within the true spirit of the invention.

What is claimed is:

1. A method for video background replacement in real time, comprising:
obtaining a video;
transmitting the obtained video;
receiving the transmitted video; and
rendering the transmitted video with a replaced background on a monitor, wherein the method further comprises obtaining an advertising content and one of:
(a) segmenting a background from the video and replacing the segmented background with the advertising content after obtaining the video and prior to transmitting the obtained video;
(b) segmenting a background from the video prior to transmitting the obtained video and replacing the segmented background with the advertising content after receiving the transmitted video; or
(c) segmenting a background from the video and replacing the segmented background with the advertising content after receiving the transmitted video.

2. The method as in claim 1, wherein segmenting the background comprises:
modeling the background of the video;
performing object segmentation to the video to obtain a foreground mask and a background mask;
filtering the background mask; and
filtering the foreground mask.

3. The method as in claim 1, wherein replacing the background comprises:
replacing the background of the video using the advertising content and the background mask to obtain the replaced background;
recompositing the video using the replaced background and a foreground mask to obtain a recomposited video; and
blending the recomposited video.

4. The method as in claim 3, further comprising:
blending the recomposited video with alpha blending.

5. The method as in claim 1, further comprising:
monitoring audio related to the video for key words; and
creating an advertising content based on the key words.

6. The method as in claim 1, wherein replacing the background comprises one of:
replacing an entire background with the advertising content, or
replacing a part of the background with the advertising content.

7. The method as in claim 1, wherein obtaining the video comprises:
obtaining the video with at least one of a pan, tilt, zoom (PTZ) camera or an omni-directional camera.

8. The method as in claim 7, wherein replacing the background with the advertising content comprises replacing the background with a warped version of the advertising content, and wherein rendering the video comprises dewarping the warped version of the advertising content.

9. The method as in claim 1, further comprising:
transmitting and receiving the video via a network.

10. The method as in claim 1, further comprising:
compressing the video after obtaining the video and prior to transmitting the video; and
decompressing the video after receiving the video and prior to rendering the video.

11. The method as in claim 1, wherein segmenting the background comprises:
obtaining a background model of the video;
performing high confidence video segmentation of the video using the background model;
updating the background model;
updating foreground and background appearance statistics; and
performing final video segmentation.

12. The method as in claim 11, wherein performing high confidence video segmentation comprises:
determining a pixel change map;
determining a gradient change map;
determining a high confidence foreground mask; and
determining a high confidence background mask.

13. The method as in claim 12, wherein determining the high confidence background mask comprises:
determining a maximum foreground convex region;
determining an initial high confidence background mask;
determining high confidence background pixels; and
determining a final high confidence background mask.

14. The method as in claim 12, wherein performing final video segmentation comprises:
performing statistical segmentation;
growing a foreground region;
performing region-based foreground hole filling; and
performing foreground boundary smoothing.

15. The method as in claim 1, wherein the advertising content comprises at least one of: an image,
a video,
an adaptive advertising content which changes during the video, or
a customizable advertising content based on a user profile.

16. A system for video background replacement in real time, comprising:
a transmitting device to obtain and transmit a video;
an advertising server to provide an advertising content via a network;
a segmentation component to segment a background from the video;
a replacement component to replace the segmented background with the advertising content; and
a receiving device to receive the video and render the video with the replaced background on a monitor.

17. The system as in claim 16, wherein the segmentation and replacement components each is embodied within at least one of the transmitting device, advertising server, or receiving device.

18. The system as in claim 16, wherein the transmitting device comprises a first computer, the receiving device comprises a second computer, and the advertising server comprises a third computer.

19. The system as in claim 16, further comprising:
a plurality of receiving devices which each receives the video and renders the video with the replaced background via the network, wherein the advertising content to replace the segmented background for each receiving device is one of identical or different.

20. A computer-readable medium holding computer-executable instructions for video background replacement in real time, the medium comprising:
instructions for obtaining a video;
instructions for transmitting the obtained video;
instructions for receiving the transmitted video;
instructions for rendering the transmitted video with a replaced background on a monitor; and
instructions for obtaining an advertising content and one of:
(a) segmenting a background from the video and replacing the segmented background with the advertising content after obtaining the video and prior to transmitting the obtained video;
(b) segmenting a background from the video prior to transmitting the obtained video and replacing the segmented background with the advertising content after receiving the transmitted video; or
(c) segmenting a background from the video and replacing the segmented background with the advertising content after receiving the transmitted video.

21. The medium as in claim 20, further comprising:
instructions for modeling the background of the video;
instructions for performing object segmentation to the video to obtain a foreground mask and a background mask;
instructions for filtering the background mask; and
instructions for filtering the foreground mask.

22. The medium as in claim 21, further comprising:
instructions for replacing the background of the video using the advertising content and the background mask to obtain the replaced background;
instructions for recompositing the video using the replaced background and a foreground mask to obtain a recomposited video; and
instructions for blending the recomposited video with alpha blending.

23. The medium as in claim 20, further comprising instructions for one of:
segmenting and replacing the background after obtaining the video and prior to transmitting the video;
segmenting the background after obtaining the video and prior to transmitting the video and replacing the background after receiving the video; or
segmenting and replacing the background after receiving the video.

24. The medium as in claim 20, further comprising instructions for one of:
replacing an entire background with the advertising content, or
replacing a part of the background with the advertising content.

25. The medium as in claim 20, wherein the video is obtained with at least one of a pan, tilt, zoom (PTZ) camera or an omni-directional camera and further comprising:
instructions for replacing the background with a warped version of the advertising content, and
instructions for dewarping the warped version of the advertising content.
